(19) United States
(12) Patent Application Publication
(10) Pub. No.: US 2003/0172021 A1
(43) Pub. Date: Sep. 11, 2003

(54) System and method using trading value for weighting instruments in an index

(76) Inventor: Chih-Wei Huang, Newport Coast, CA (US)

Correspondence Address: Brian M. Berliner, O'MELVENY & MYERS LLP, 400 South Hope Street, Los Angeles, CA, 90071-2899, US

(21) Appl. No.: 10/385,959

(22) Filed: Mar. 11, 2003

Related U.S. Application Data
(63) Continuation-in-part of application No. 09/970,736, filed on Oct. 3, 2001.

(51) Int. Cl. G06F 17/60

(52) U.S. Cl. 705/36

(57) ABSTRACT

A system and method is disclosed for measuring performance of trading instruments within a market. More specifically, the system comprises a data receiving device that is adapted to receive data and a processor in communication with the data receiving device. The data includes monetary value of shares of each of at least two instruments traded during a particular time period data and volume of the shares of each of the at least two instruments traded over said particular time period data. The processor is adapted to provide the functions of multiplying the monetary value of shares of each of the at least two instruments with the volume of shares of each of the at least two instruments to determine a trading value of each of the at least two instruments for the particular time period. The processor is also adapted to provide the function of creating an index based in part on the trading value of each of the at least two instruments.

### RELATED APPLICATION

This application is a continuation-in-part of co-pending application Ser. No. 09/970,736, filed Oct. 3, 2001, entitled “System And Method For Measuring Performance Of Trading Instruments Within A Market.”

### BACKGROUND OF THE INVENTION

1. Field of the Invention

The present invention relates to a system and method for evaluating the performance of trading instruments within a market. More specifically, the present invention relates to a system and method for weighting an index using trading value.

2. Description of Related Art

There are many applications in economics, marketing, supply chain management and financial markets where forecasting with the best attainable accuracy is of crucial importance. Investors often turn to theories and complex calculations in order to predict how particular markets will behave. The goal of forecasting, prediction, or valuation is thus to generate an accurate value of a publicly-traded trading security or instrument (e.g., stocks, bonds, currency, commodities, etc.) (referred to herein as a trading instrument) directly from a given set of data pertaining to this particular trading instrument.

Investors currently use different combinations of any of a plurality of performance measures (e.g., price-to-earnings ratio, market capitalization, etc.) in order to make predictions. Investors also attempt to gain perspective on market fluctuations by comparing the movement of particular trading instruments relative to that of indices. It should be appreciated that indices are herein defined as any of a plurality of rankings determined by using any of several performance measures or combinations thereof. Although different indices are calculated in different ways, all indices measure the performance of a particular market or some subsection of it on a continuing basis throughout each trading day. By tracking an index, or a variety of indices, investors can quickly gauge market trends that may impact investment decisions. Indeed, overall market performance can be useful in making decisions about individual investments. For example, indices can function as benchmarks to compare the performance of particular trading instruments against the market in general. Furthermore, by comparing today's market movement with similar market movements from the past, an investor may gain useful insight on the best times to buy or sell.

In 1896 The Dow Jones Company took groups of stocks and averaged their prices to create the first indices, known as the Dow Jones Averages. They created four different indices: one for industrial companies, one for utilities, one for transportation companies, and a composite that included the three other indices. Initially, the Dow Jones Industrial Average was developed to represent the current business market, which in 1896 included industries such as sugar, leather, tobacco, gas, rubber and coal. The Dow Jones Industrial Average is now one of the best-known market indicators and is comprised of 30 leading companies. Calculated by adding the prices of these 30 stocks, the Dow is now considered a figure that indicates the general state of the market. Originally, the Dow divided the sum of the prices of the 30 stocks by a divisor of 30, giving a true average. However, to be consistent every time a stock split or paid a dividend, the divisor had to be adjusted. Now, over 100 years later, the sum of the prices of the 30 stocks is divided by a divisor of less than one. Since a $1 movement in the price of a $100 stock counts equally with a $1 movement in the price of a $20 stock, the Dow Jones is considered a price-weighted index.

In the 1920s, Standard & Poor's Corporation (S&P) created separate indices that also measured the market as a whole in addition to only some sectors of the market. In 1957, when technology enabled companies to start calculating their indices on an hourly basis, S&P created the S&P 500 Index, which measured the performance of a larger proportion of the market compared to the more popular Dow Jones Industrial Index. In particular, this index tracks 500 companies in leading industries: transportation, utilities, financial services, technology, health care, energy, communications, services, capital goods, basic materials, consumer products, cyclicals and more. Many consider the S&P 500 Index the most accurate reflection of the U.S. stock market today. This high regard has led many money managers and pension plan administrators to use it as a benchmark for judging the overall performance of their fund against the stock market.

The calculation for this index corresponds to the price of each stock multiplied by the number of shares held by the public, which is the market value of the outstanding shares of each stock. Thus, the companies with the most shares make the greatest impact. This is known as a market weighted index. The S&P 500 is also base weighted, which means that the market value of the stocks in the index during a base period is related to a base index value and a base period index divisor. Relating the market value to a base index value allows investors to more easily compare the present status of the market to the status of the market during the base period. And, because the base period index divisor is adjusted for stock splits and other corporate actions, the corporate actions do not affect the accuracy of the S&P 500 Index as a measure of the market; and, the corporate actions do not affect the continuity of the S&P 500 Index, allowing for accurate comparison of current market states to previous market states.

A problem with existing indices based on current performance measures (e.g., price weighted indices and market weighted indices) is that they do not provide an accurate measure of the market because they are weighted by price and market value. Price and market value based indices only take into account the value and/or the number of outstanding shares of a particular trading instrument, but do not take into account how much the shares are traded. This results in an inaccurate measure of the market because, even though a large portion of shares of many trading instruments are owned by long term investors who do not trade their shares, the shares that are not traded still greatly affect the price and market weighted indices. Another problem with indices based on current performance measures is that they do not provide a measure of volume-dependent market trends, and, consequently, investors do not have a tool to monitor volume-dependent market trends by comparing market volume trends in the past to current market volume trends. The ability to monitor volume-dependent market trends, however, may impact investment decisions.

Accordingly, it would be desirable to create an index that provides an accurate measure of the market, and it would also be desirable for such an index to allow investors to monitor volume-dependent market trends.

### SUMMARY OF THE INVENTION

The present invention is directed towards a system and method that provides an accurate measure of the market by weighting trading instruments by their trading values. The invention also allows investors to monitor volume-dependent market trends.

In an embodiment of the invention, the system comprises a data receiving device and a processor in communication with the data receiving device. The data receiving device is adapted to receive data, and the data includes monetary value of shares of each of at least two instruments traded during a particular time period data and volume of the shares of each of the at least two instruments traded over said particular time period data. The processor is adapted to provide the functions of multiplying the monetary value of shares of each of the at least two instruments with the volume of shares of each of the at least two instruments to determine a trading value of each of the at least two instruments for the particular time period. The processor is also adapted to provide the function of creating an index based in part on the trading value of each of the at least two instruments. The trading instruments are weighted by their trading values because the index is based on their trading values, which is a measure of the trading movement for an instrument. As a result, the index provides a more accurate measure of the state of several trading instruments.

In other embodiments of the invention, the processor is further adapted to sum the trading value of the at least two instruments for the time period with one another to determine a market trading value. The processor may also set the market trading value equal to an index value, and divide the market trading value by the index value to determine an index divisor. By setting the market trading value equal to an index value, investors can monitor volume-dependent market trends by comparing market volume trends in the past to current market volume trends.

In other embodiments of the invention, the data received by the data receiving device also includes updated monetary value of shares during a successive time period data and updated volume of the shares traded over the successive time period data. And, the processor is further adapted to multiply the updated monetary value of shares data with the updated volume of shares data in order to determine an updated trading value for each of the at least two instruments for the successive time period. The processor is also adapted to sum the updated trading value of each of the at least two instruments to determine an updated market trading value.

In another embodiment, the processor is further adapted to adjust the index divisor when there is a divisor changing event in order to determine a latest index divisor, and to determine a latest index value by dividing the updated market trading value by the latest index divisor. Because the index divisor is adjusted for divisor changing events, the accuracy of the index value as a measure of market volume trends is not distorted by the divisor changing events, which can be, for example, corporate spin-offs and rights offerings.

A more complete understanding of a system and method for providing an accurate measure of the market will be afforded to those skilled in the art, as well as a realization of additional advantages and objects thereof, by a consideration of the following detailed description of the preferred embodiment. Reference will be made to the appended sheets of drawings that will first be described briefly.

### BRIEF DESCRIPTION OF THE DRAWINGS

FIG. 1 is a block diagram illustrating how a trading value is calculated;

FIG. 2 is a block diagram illustrating a trading value generator of the invention implemented within a communications network;

FIG. 3 is a flow chart describing a procedure that a trading value generator follows while calculating trading values; and

FIG. 4 is a flow chart describing a procedure for generating an index according to an embodiment of the invention;

FIG. 5 is a flow chart describing a procedure for weighting trading instruments by trading values according to an embodiment of the invention;

FIG. 6 is a flow chart describing a procedure for adjusting an index divisor when a trading instrument is to be added to an index, based on an embodiment of the invention; and,

FIG. 7 is a flow chart describing a procedure for adjusting an index divisor for corporate actions based on an embodiment of the invention.

### DETAILED DESCRIPTION OF THE PREFERRED EMBODIMENT

The present invention satisfies the need for an improved system and method for providing an accurate measure of the market. More specifically, the present invention satisfies the need for providing an accurate measure of the market by weighting trading instruments by their trading values, which is a measure of the value of shares traded. The trading value is calculated according to the trading volume (i.e., number of shares traded) of a particular trading instrument and its corresponding unit price (i.e., the price of each share).

In an embodiment of the invention, trading instruments are selected, and a trading value is calculated for each selected trading instrument. The trading values of each of the selected trading instruments is used to weight each trading instrument, and because the trading values reflect volume-dependent trends for the trading instruments, the index provides an accurate measure of the market. In another embodiment, the index is base weighted to allow investors to compare current market volume activity to market volume activity of prior periods. In another embodiment, the index is calculated using an index divisor that is adjusted for divisor changing events. Because the index divisor is adjusted for divisor changing events, the accuracy of the index value as a measure of market volume trends is not distorted by the divisor changing events, which can be, for example, corporate spin-offs and rights offerings.

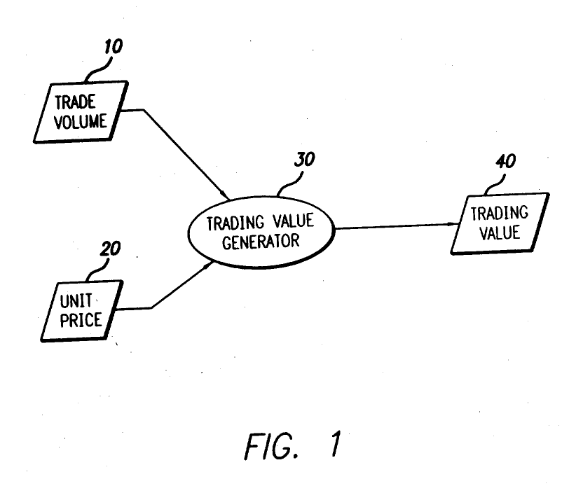

Referring to FIG. 1, a block diagram illustrating how trading values are calculated is provided. As illustrated, trade volume 10 and unit price 20 are input to trading value generator 30 in order to generate trading value 40. In a preferred embodiment, trading value generator 30 represents a multiplier that multiplies trade volume 10 by unit price 20 in order to calculate a particular trading value 40. This preferred embodiment might thus be defined by the following equation:

TradingValue=(Unit)×(Volume)

where unit price 20 (Unit) is defined as the monetary value of each share traded during a given time, and trade volume 10 (Volume) is defined as the total number of shares traded at this given time. In another embodiment of the present invention, aggregate trading values 40 may be obtained for particular intervals of time. For example, a daily trading value 40 for a particular trading instrument may be obtained by taking the sum of all trading values 40 for that day pertaining to this instrument. More specifically, this daily trading value 40 may be obtained using the following equation:

$$TradingValue ( day ) [ Unit , Volume ] = {\sum }_{i = 1}^{j} [ {( Unit )}_{i} \times {( Volume )}_{i} ]$$

where it is understood that this daily trading value is the sum of all trading values 40 for that particular day. It should be appreciated that, within this example, a plurality of instants in time for this particular day is given by the interval [i, j]. In particular, this daily trading value is the sum of j trading values 40 individually calculated by respectively multiplying the unit price (Unit)ᵢ at a given time by its corresponding trade volume (Volume)ᵢ.

In an alternative embodiment, a daily trading value may be calculated by taking the total number of trades in a given day and multiplying it by the average unit price of the trading instrument for the desired day. Within such embodiment, it should thus be appreciated that a daily trading value may be obtained by using the equation:

$$TradingValue ( day ) [ AvgUnit , Volume ] = AvgUnit {\sum }_{i = 1}^{j} [ {( Volume )}_{i} ]$$

where it is understood that this daily trading value is calculated by taking the average unit price (AvgUnit) of the trading instrument for that particular day and multiplying it by the total trade volume for that day. It should be further understood that, in the equation above, j represents the sum of all individual “trade volumes” taken at every i-th interval of a given day. Nevertheless, any of a plurality of temporal types of trading values (e.g., hourly, daily, weekly, monthly, quarterly, annually, etc.) may similarly be derived.

An exemplary investor can use the trading value information, alone or in conjunction with other performance measures, to select individual securities for investment. For example, an institutional investor desiring to make a substantial investment in the market (e.g., several millions of dollars) may consult the trading value information to select securities that can absorb a sizable investment without having an adverse market reaction. If the stock of a particular company has a daily trading value in excess of $500 million, then the purchase of $1 million of that stock would likely not affect the market price. In contrast, the stock price of another company that has a daily trading value under $5 million would likely be very affected by a $1 million stock purchase. For yet another company having a daily trading value under $1 million, it may not be possible to acquire $1 million worth of stock since an insufficient amount of stock is traded to satisfy such a large purchase. The availability of trading value information can therefore benefit greatly an investor's trading decisions.

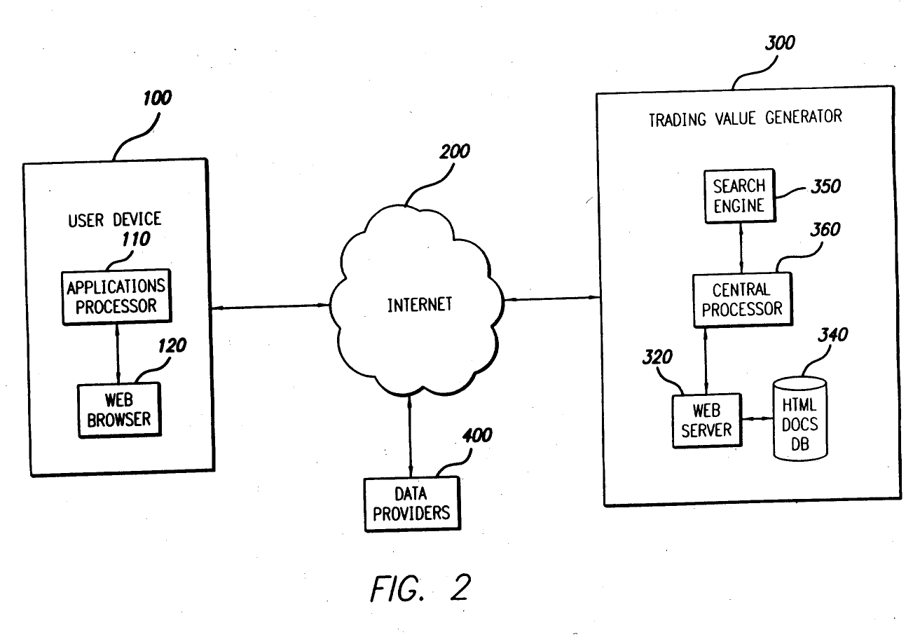

It should be appreciated that any of the aforementioned embodiments may also be implemented within a communications network, such as the Internet, so that users may obtain trading value information from remote locations. In FIG. 2, a block diagram of one such implementation is provided. In particular, an trading value generator 300 is shown to be connected to a user device 100 and various data providers 400 via the Internet 200. Although the Internet is used in this particular example, it should be noted that equivalent communication mediums might include local area networks (LANs), wide area networks (WANs), and other communication systems and networks.

Within such embodiment, it should be appreciated that the trading value generator 300 may be implemented as an application accessible through an Internet interface, such as the World Wide Web, using conventional interface protocols such as TCP/IP. As illustrated in FIG. 2, trading value generator 300 is shown to be comprised of a central processor 360 coupled to a search engine 350, and a Web server 320 connected to an HTML documents database 340. Meanwhile, user device 100 is shown to be further comprised of an applications processor 110 coupled to a Web browser 120. Within such embodiment, it should be further appreciated that user devices 100, trading value generator 300, and data providers 400 may comprise a computing device, such as a personal computer, laptop, personal digital assistant, and the like.

As is generally known in the art, search engines such as search engine 350 typically incorporate a database engine, such as a SQL Server™ engine from Microsoft Corporation or Oracle™ database engine, as part of their architecture. It is also well known in the art that such search engines typically perform searches by operating on a string of characters, known as a “query string.” A query string is coded according to a set of rules determined by the database engine and/or a user interface between the database engine and the user. As used herein, a “query” is broader than a “query string,” denoting both the query string and the search logic represented by the query string, whereas “query string” refers only to a string of characters, symbols, or codes used to define a query.

As is also generally known in the art, Web servers such as Web server 320 access a plurality of Web pages, distributable applications, and other electronic files containing information of various types stored in a storage device, such as an HTML document database 340. As a result, Web pages may be viewed on various user devices 100; for example, a particular Web page or other electronic file may be viewed through a suitable application program residing on a user device 100, such as a browser 120 or by a distributable application provided to the user device 100 by Web server 320. It should be appreciated that many different user devices 100, data providers 400, and many different Web servers 320 may be communicating with each other at the same time.

It should be further appreciated that user devices 100 may be represented by any type of the aforementioned computing devices that allow a user to interactively browse websites, such as a personal computer (PC) that includes a Web browser application 120 (e.g., Microsoft Internet Explorer™ or Netscape Communicator™). Suitable user devices 100 equipped with browsers 120 are available in many configurations, including handheld devices (e.g., PalmPilot™), personal computers (PC), laptop computers, workstations, television set-top devices, multi-functional cellular phones, and so forth.

Within this embodiment, a user device 100 identifies a Web page that is desired to be viewed at the user device 100 by communicating an HTTP (Hyper-Text Transport Protocol) request from the browser application 120. The HTTP request includes the Uniform Resource Locator (URL) of the desired Web page, which may correspond to an HTML document stored in the HTML documents database 340. The HTTP request is routed to the Web server 320 via the Internet 200. The Web server 320 then retrieves the HTML document identified by the URL, and communicates the HTML document across the Internet 200 to the browser application 120. The HTML document may be communicated in the form of plural message packets as defined by standard protocols, such as the Transport Control Protocol/Internet Protocol (TCP/IP).

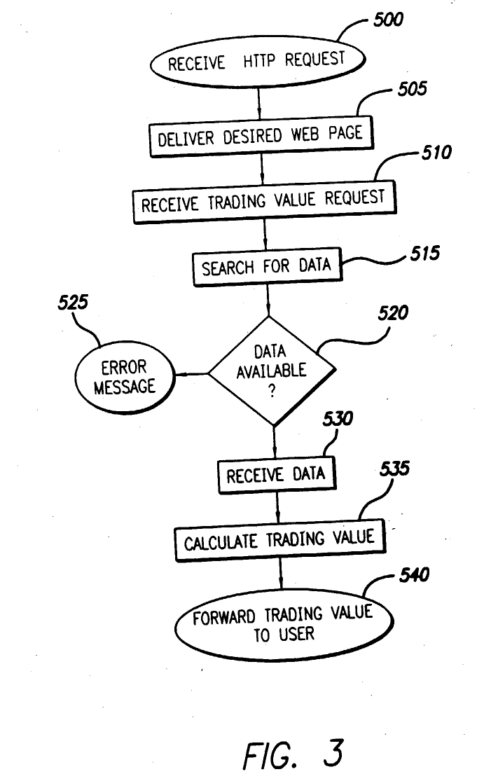

Referring to FIG. 3, a flow chart illustrating the procedure followed by the trading value generator 300 within this embodiment is provided. This procedure begins at step 500 when the trading value generator 300 receives an HTTP request from a user device 100. At step 505, the trading value generator 300 then delivers the requested Web page to the user device 100. Once the user device 100 has obtained access to the trading value generator 300, a user may choose to ascertain any of a plurality of trading values 40 available. In particular, a user may choose to obtain trading values 40 of any trading instrument available to the trading value generator 300 from data providers 400.

Once the user has selected which trading value 40 it desires, the trading value generator 300 receives this request at step 510. The trading value generator 300 then proceeds by searching for the data necessary for calculating the requested trading value 40 at step 515. In particular, trading value generator 300 uses search engine 350 in order to search for relevant data (i.e., trade volume 10 and unit price 20) pertaining to this calculation from databases provided by any of various data providers 400.

At step 520, the trading value generator 300 then determines whether it has sufficient data to calculate the requested trading value 40. If sufficient data is not available at step 520, then the trading value generator 300 proceeds by sending the user device 100 an error message at step 525; otherwise, the necessary data is received from data providers 400 at step by a data receiving device (not shown). At step 535, the requested trading value 40 is then calculated using the data received at step 530. Once this trading value 40 is calculated, the trading value generator 300 then concludes this procedure by forwarding this value to user device 100 at step 540.

In another embodiment, the data providers 400 may automatically send relevant data (i.e., trade volume 10 and unit price 20) pertaining to trading value calculations for predetermined trading instruments, and the data receiving device (not shown) of the trading value generator 300 may receive the data. The central processor 360 can then use the data received to calculate trading values 40 for the predetermined trading instruments.

It should be appreciated that, once a trading value 40 has been generated using any of the aforementioned embodiments, any of a plurality of indices may be readily created. Moreover, it should be appreciated that this trading value 40 may be used either alone or in conjunction with other performance measures in order to create an index. By creating such an index, investors may thus gain perspective on market fluctuations by comparing the movement of particular trading instruments relative to that of other trading instruments within the newly created index. As a result, investors are provided with an accurate measure of the market that monitors current volume-dependent market trends that may impact investment decisions.

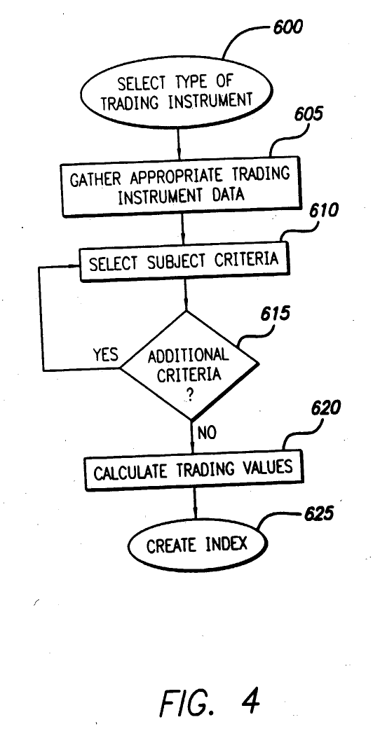

Referring to FIG. 4, a flow chart illustrating the procedure for providing an accurate measure of the market according to an embodiment of the invention is provided. It should be appreciated that, although the following procedure is described with respect to a particular investor, these steps may be similarly followed by any entity attempting to create an index. An investor initiates this procedure, at step 600, by selecting a particular type of trading instrument (e.g., stocks, bonds, currency, commodities, etc.) from which to index. At step 605, the investor then ascertains a list of all trading instruments corresponding to the selection made at step 600. From this list, the investor would then extract a subset of trading instruments pertaining to specific categories (i.e., trading instruments pertaining to a specific industry, trading instruments typically traded in high/low volumes, etc.) by selecting desired criteria at step 610.

After having generated a particular subset of trading instruments at step 610, the investor must then determine if she wants to further narrow this subset to include only those trading instruments that comply with an additional criteria at step 615. More specifically, if the investor chooses to revise her subset at step 615, then the investor returns to step 610 where she selects an additional criteria from which to further narrow the current subset; otherwise, the investor proceeds by calculating trading values 40 for each trading instrument within the generated subset at step 620. Note that, in one embodiment, the steps of extracting a subset of trading instruments 610 and narrowing the subset of trading criteria 615 include selecting predetermined instruments that are to be used in an index having a large number of constituent trading instruments. For example, for an entity that publishes an index, the entity may have a large number of predetermined constituent trading instruments that it includes in its index, and the entity selects the predetermined trading instruments by sending requests to the trading value generator 300 to calculate the trading values 40 for each of the predetermined constituent trading instruments. Once these trading values 40 are calculated, the investor (or entity) may then create an index by ranking individual ones of these trading instruments according to an algorithm that is weighted towards these respective trading values 40 at step 625. The trading values 40 are typically calculated based on a particular time period, which can be, for example, hourly, daily, weekly, monthly, quarterly, annually, etc.

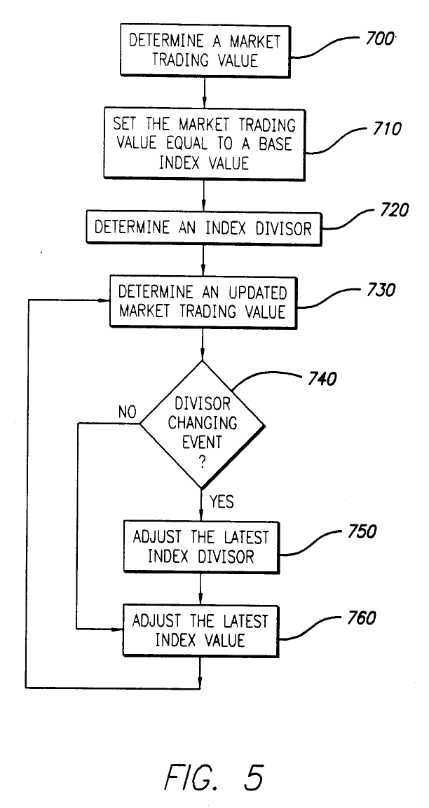

Pursuant to one embodiment of the invention, the steps that are followed in one algorithm to weight trading instruments by their respective trading values 40 is shown in FIG. 5. At step 700, a market trading value is determined by summing the trading values of each of the trading instruments within the subset chosen at steps 610 and 615 (FIG. 4). At step 710, the market trading value is then set equal to a base index value for a base time period. In a preferred embodiment, the base time period is the same temporal length as the particular time period used in calculating the trading values for each trading instrument. The base index value may be an arbitrary value, and in one embodiment, the index value is one-hundred. Choosing an even base index value, such as one-hundred, allows investors to more easily graph index values and to more easily compare a recent or current index value to the base index value. Thus, by using the base index value for the trading value weighted index, investors can more easily understand how current volume-dependent market trends compare to volume-dependent market trends of the past.

At step 720, the index divisor is determined by dividing the market trading value by the base index value. The index divisor remains constant, for the most part, and is used when the index value is updated to reflect current volume-dependent market trends for successive time periods; sometimes, however, when there are divisor changing events (discussed below), the index divisor should be adjusted to maintain continuity of the index. At step 730, the market trading values are updated during successive time periods, and the time periods may vary depending on user preferences and the capabilities of the user device 100, the trading value generator 300, and the data providers 400. The time periods can be, for example, hourly, daily, weekly, monthly, quarterly, or yearly, and in a preferred embodiment, the successive time periods are of the same temporal length as the base time period. The same temporal length time periods allows for the updated market trading value to be easily compared to the market trading value for the base time period; if different time periods were to be used, it would be more difficult to compare the updated market trading value to the market trading value during the base period. If, for example, the base time period was hourly and the updated time period was weekly, the base market trading value would reflect the value of shares that have been traded over an hour period and the updated market trading values would reflect the value of shares that have been traded over a week period; and, because there would be inherently more trades during a week than in an hour, the market trading values for the two periods would be difficult to compare to one another.

To update the market trading values, at step 730, for each successive time period, the trading value generator 300 collects trade volume 10 and unit price 20 data from the data providers 400 for each of the trading instruments in the subset extracted by the investor (or entity). The trade volume 10 is multiplied by the unit price 20 for each trading instrument to determine updated trading values 40 for the successive time period, and all of the updated trading values for each trading instrument are summed together to determine an updated market trading value.

At step 740, it is determined if there is a divisor changing event, and if so, a latest index divisor is adjusted at step 750; otherwise, the index divisor is not changed, and the index value is updated at step 760 by dividing the updated market value by the latest index divisor. Divisor changing events include changing one trading instrument in the index for another, or an action performed by a corporation whose trading instruments are in the index; for example, a corporate action of spinning-off a corporation or product division into an independent corporation is a divisor changing event. As those skilled in the art will appreciate, the index divisor should be adjusted when divisor changing events occur to ensure that the index value is not distorted by changing one trading instrument for another or by corporate action. Index divisor adjustment allows the index to remain continuous, which allows updated index values to be compared to the base index value; and, index divisor adjustment also allows the index to remain an accurate reflection of market volume trends despite corporate actions, as is described in greater detail below.

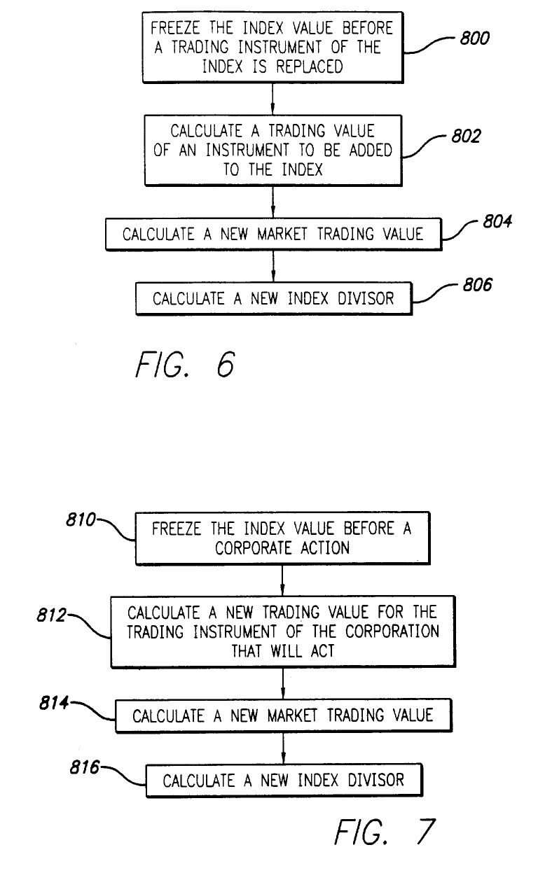

If an investor or entity wishes to change one trading instrument of the index for another, the index divisor must be changed to maintain index continuity. If the divisor were not changed, the market trading value would be affected by the different monetary share prices of the instruments to be added and removed, and the updated index values would not provide an accurate comparison to the base index value. The flow chart of FIG. 6 describes the procedure used to adjust the index divisor to maintain continuity, and Table 1 (provided below) shows how the index divisor is adjusted in an index comprised of three instruments when one instrument (Company D shares) will replace another instrument (Company B shares). At step 800 (FIG. 6), the latest index value, before the change, is calculated by dividing the market trading value, before the change, by the latest index divisor, before the change; the index value is then frozen, i.e., kept constant. In Table 1, the frozen index value is 120. The trading value for the trading instrument to be added is then calculated at step 802, and in Table 1, the trading value of Company D trading instruments is $6,000,000. A new market trading value is calculated at step 804 by replacing the trading value of the instrument to be replaced with the trading value of the trading instrument to be added. The remaining trading values of the trading instruments that were not removed and the trading value of the instrument to be added are added together to calculate the new market trading value. The new market value in Table 1 is $15,000,000. At step 806, the latest index divisor is calculated by dividing the new market trading value by the frozen index value, and as shown at step 760 (FIG. 5), the latest index value is determined by dividing the updated market value by the latest index divisor. In Table 1, the latest index divider is 125,000.

TABLE 1

| | | | |
|---|---|---|---|
| | Price for | Volume of Shares Traded | |
| Stock | Time Period | During Time Period | Trading Value |

Step 800: Calculate Index Value Before Change in Trading
Instrument And Freeze The Value

| | | | |
|---|---|---|---|
| Company A | $30 | 50,000 | $1,500,000 |
| Company B | 30 | 100,000 | 3,000,000 |
| Company C | 50 | 150,000 | 7,500,000 |

| | |
|---|---|
| Market Trading Value | $12,000,000 |

Market Trading Value/Latest Index Divisor = Index Value
12,000,000/100,000 = 120
Steps 802 and 804: Calculate Trading Value for Company D
and Replace Trading Value of Company B with Trading Value
of Company D to Calculate New Market Trading Value.

| | | | |
|---|---|---|---|
| Company A | $30 | 50,000 | $1,500,000 |
| Company D | 40 | 150,000 | 6,000,000 |
| Company C | 50 | 150,000 | 7,500,000 |

| | |
|---|---|
| New Market Trading Value | $15,000,000 |

Step 806: Calculate Latest Index Divisor:

15,000,000/Latest Divisor = 120
15,000,000/120 = 125,0000
Latest Index Divisor = 125,0000

Some corporate actions, such as spin-offs, a special cash dividend, or rights offerings, cause the monetary share price of the trading instrument to drop, and to ensure that such corporate actions do not affect the accuracy of the index, the index divisor is adjusted. If the index divisor were not adjusted, the index would be affected by the corporate action, which would distort the accuracy of the index as a measure of the market trading volume trends. The flow chart of FIG. 7 describes the procedure used to adjust the index divisor to maintain index accuracy, and Table 2 (provided below) shows how the index divisor is adjusted in an index comprised of three instruments when one corporation (Company D) announces a corporate action. At step 810, if a corporation whose trading instrument is in the index announces a corporate action, an index value is calculated before the effective date of the corporate action by dividing the market trading value, before the corporate action, by the index divisor, before the corporate action; the index value (before the action) is then frozen. In Table 2, the frozen index value is 170. At step 812, a new trading value for the trading instrument of the corporation that will act is calculated. Specifically, the monetary share price of the trading instrument is lowered by an adjustment amount to determine a new monetary share price, and the new monetary share price is multiplied by the volume of shares traded during the time period to determine a new trading value for the trading instrument. In Table 2, Company C has announced a corporate event, the adjustment amount is $10, and the new market value of Company C is $6,000,000.

The adjustment amount is different depending on the corporate action. A spin-off is when a corporation sells a subsidiary corporation or product division and makes the subsidiary or product division an independent corporation. The adjustment amount for a spin-off is the share price of the company to be spun-off (to be sold) divided by the share exchange ratio, where the share exchange ratio is the number of shares that the shareholder must own to receive one share of the company to be spun-off. For example, if the share price of the company to be spun-off is $50, and each share holder receives one share of the company to be spun-off for every five shares of the corporation the share holder owns, the share exchange ratio is five and the adjustment amount is $10. For a special cash dividend, the adjustment amount is the amount of the cash dividend. A rights offering is when shareholders have the right to buy new shares of the corporation when the corporation issues additional shares. The adjustment amount for a rights offering is the price of the rights divided by a rights ratio, where the price of the rights is the amount a shareholder must pay for an additional share that is issued and where the rights ratio is the number of shares a shareholder must own to have the right to buy an additional share, at the price of the rights. For example, if the price of the rights is $50, and each shareholder must own five shares to have the right to purchase one additional share of stock for $50, the rights ratio is five and the adjustment amount is $10.

At step 814, the new trading value of the trading instrument is used to calculate a new market trading value by using the new trading value for the instrument. The new trading value and the trading values of the other trading instruments in the index are then added together to provide the new market trading value, and in Table 2, the new market trading value is $15,500,000. At step 814, the new market trading value is divided by the frozen index value to provide a latest index divisor, and in Table 2, the latest index divisor is 91,176.5.

TABLE 2

| | | | |
|---|---|---|---|
| | Price for | Volume of Shares Traded | Market |
| Stock | Time Period | During Time Period | Trading Value |

Step 810: Calculate Index Value Before Corporate Action
and Freeze The Value

| | | | |
|---|---|---|---|
| Company A | $35 | 100,000 | $3,500,000 |
| Company B | 40 | 150,000 | 6,000,000 |
| Company C | 50 | 150,000 | 7,500,000 |

| | |
|---|---|
| Market Trading Value | $17,000,000 |

Total Market Value/Latest Index Divisor = Index Value
17,000,000/100,000 = 170
Steps 812 and 814: Calculate A New Trading Value For
Instrument Corresponding To Corporation That Will Act And
Calculate A New Market Trading Value Based Using
The New Trading Value.

| | | | |
|---|---|---|---|
| Company A | $35 | 100,000 | $3,500,000 |
| Company B | 40 | 150,000 | 6,000,000 |
| Company C | 40 | 150,000 | 6,000,000 |
| Total | $15,500,000 | | |

Step 816 Calculate Latest Index Divisor:

15,500,000/Latest Divisor = 170
15,500,000/170 = 91,176.5
Latest Divisor = 91,176.5

At step 760 (FIG. 5), the latest index value is determined by dividing the updated market value by the latest index divisor. After the latest index value is determined at step 760, another updated market value for the next successive time period is calculated again at step 730, and the process repeats itself. Typically, this process is performed by the trading value generator 300.

It is envisioned that such an index based on trading value may be publicly disseminated in the form of a publication or report to investors. The index would include companies ranked in order of their trading value based on a daily, weekly, monthly, quarterly, annual or other perspective. Moreover, stock funds may be formed that focus entirely or at least partially on investments within companies listed on such an index. Exemplary indices may include the five-hundred companies having the largest trading value (LTV 500), the one-hundred companies having the largest trading value (LTV 100), or other similar rankings.

Having thus described a preferred embodiment of a system and method for providing an accurate measure of the market by weighting trading instruments by their trading values, it should be apparent to those skilled in the art that certain advantages of the within system have been achieved. It should also be appreciated that various modifications, adaptations, and alternative embodiments thereof may be made within the scope and spirit of the present invention. The invention is further defined by the following claims.

What is claimed is:

1. A method of evaluating performance of trading instruments, comprising the steps of:
determining monetary value of shares of each of at least two instruments traded during a particular time period;
determining volume of said shares of each of the at least two instruments traded over said particular time period;
multiplying said monetary value of shares of each of the at least two instruments with said volume of shares of each of the at least two instruments to determine a trading value of each of the at least two instruments for said particular time period; and,
creating an index based in part on the trading value of each of the at least two instruments.

2. The method of claim 1, further comprising selecting the at least two instruments for the index.

3. The method of claim 1, wherein said creating step further comprises summing the trading value of each of the at least two instruments for said particular time period with one another to determine a market trading value.

4. The method of claim 3, wherein said creating step further comprises setting the market trading value equal to an index value.

5. The method of claim 4, wherein said creating step further comprises setting a time period corresponding to the index value equal in temporal length to said particular time period.

6. The method of claim 4, wherein said creating step further comprises setting the index value equal to one-hundred.

7. The method of claim 4, wherein said creating step further comprises dividing the market trading value by the index value to determine an index divisor.

8. The method of claim 7, further comprising the steps of determining updated monetary value of shares of each of the at least two instruments during a successive time period, determining updated volume of said shares of each of the at least two instruments traded over the successive time period, multiplying said updated monetary value of shares of each of the at least two instruments with said updated volume of shares of each of the at least two instruments to determine an updated trading value of each of the at least two instruments for the successive time period, and summing the updated trading value of each of the at least two instruments to determine an updated market trading value.

9. The method of claim 8, further comprising the step of setting the successive time period equal in temporal length to a base time period.

10. The method of claim 8, further comprising adjusting the index divisor when there is a divisor changing event to determine a latest index divisor.

11. The method of claim 10, wherein the adjusting step further comprises calculating an index value before a trading instrument is to be added and before one of the at least two trading instruments is to be removed from the index, freezing the calculated index value, calculating a trading value for the trading instrument to be added, calculating a new market trading value using the trading value of the instrument to be added, and calculating the latest index divisor by dividing the new market trading value by the frozen index value.

12. The method of claim 10, wherein the adjusting step further comprises calculating an index value before an entity corresponding to one of the at least two trading instruments performs a divisor changing action, freezing the calculated index value, calculating a new trading value for the one of the at least two trading instruments based on an adjustment value, calculating a new market trading value using the new trading value of the one of the at least two trading instruments, and calculating the latest index divisor by dividing the new market trading value by the frozen index value.

13. The method of claim 12, wherein the calculating the index step further comprises calculating the index value before the entity spins-off a corporation, and wherein the calculating a new trading value step further comprises dividing a price per share of the corporation to be spun-off by a share exchange ratio to determine the adjustment value.

14. The method of claim 12, wherein the calculating the index step further comprises calculating the index value before the entity issues a special cash dividend, and wherein the calculating a new trading value step further comprises setting the adjustment value equal to an amount of the cash dividend.

15. The method of claim 12, wherein the calculating the index step further comprises calculating the index value before the entity issues a rights offering, and wherein the calculating a new trading value step further comprises dividing a price of rights of shares to be issued by a rights ratio to determine the adjustment value.

16. The method of claim 10, further comprising determining a latest index value by dividing the updated market value by the latest index divisor.

17. An index generated in accordance with the method of claim 1.

18. A system for weighting trading instruments by trading values, comprising:
a data receiving device adapted to receive data, wherein the data comprises monetary value of shares of each of at least two instruments traded during a particular time period data and volume of said shares of each of the at least two instruments traded over said particular time period data; and,
a processor in communication with the data receiving device, wherein the processor is adapted to provide the functions of:
multiplying said monetary value of shares of each of the at least two instruments data with said volume of shares of each of the at least two instruments data to determine a trading value of each of the at least two instruments for said particular time period; and,
creating an index based in part on the trading value of each of the at least two instruments.

19. The system of claim 18, wherein said creating function further comprises summing the trading value of each of the at least two instruments for said particular time period with one another to determine a market trading value.

20. The system of claim 19, wherein said creating function further comprises setting the market trading value equal to an index value.

21. The system of claim 20, wherein said creating function further comprises dividing the market trading value by the index value to determine an index divisor.

22. The system of claim 21, wherein the data that the receiving device is adapted to receive further comprises updated monetary value of shares of each of the at least two instruments during a successive time period data and updated volume of said shares of each of the at least two instruments traded over the successive time period data, and wherein the processor is further adapted to multiply said updated monetary value of shares of each of the at least two instruments data with said updated volume of shares of each of the at least two instruments data to determine an updated trading value of each of the at least two instruments for the successive time period and to sum the updated trading value of each of the at least two instruments to determine an updated market trading value.

23. The system of claim 22, wherein the processor is further adapted to adjust the index divisor when there is a divisor changing event to determine a latest index divisor.

24. The system of claim 22, wherein the processor is further adapted to determine a latest index value by dividing the updated market trading value by a latest index divisor.
